(19) United States
(12) Patent Application Publication
(10) Pub. No.: US 2002/0070358 A1
(43) Pub. Date: Jun. 13, 2002

(54) Carton sterilization method and apparatus

(76) Inventor: Lars Aksel Thingelstad, Drammen (NO)

Correspondence Address: REISING ETHINGTON BARNES KISSELLE, LEARMAN AND MCCULLOCH PC, P O BOX 4390, TROY, MI, 48099-4390, US

(21) Appl. No.: 09/977,429

(22) Filed: Oct. 15, 2001

(30) Foreign Application Priority Data
Oct. 14, 2000 (GB) 0025284.1

(51) Int. Cl. G21F 5/02

(52) U.S. Cl. 250/496.1

(57) ABSTRACT

A form-fill-seal packaging machine has, between blank feeder and loader assemblies thereof, on the one hand, and an indexing mandrel spider upon which the cartons are bottom-closed and-sealed, on the other hand, another indexing spider upon which micro-organisms in the interior of the carton sleeve, particularly upon the inside surface thereof, are rendered non-viable. Each of the arms of this spider consists of a device and angle-form, carton sleeve guides distributed parallelly around the device at the corners of a square co-axial with the device and of a size fittingly to receive a carton sleeve. Each device includes an excimer UV-C-lamp which is water-cooled. The lamp includes an elongate support member in the form of a rod of which an inner end is fixed to the hub of the spider and of which the outer end may optionally have a mandrel cap fixed thereto. The mandrel cap contains conduits leading to a nozzle which is at the outer extremity of the device and is co-axial with the rod. The nozzle emits a spray of hydrogen peroxide solution substantially perpendicularly to the axis of the rod throughout 360° around that axis.

### BACKGROUND OF THE INVENTION

1. Field of the Invention

This invention relates to a method of rendering nonviable micro-organisms in a partially completed container and to apparatus for use in the method.

Disclosure of the Prior Art

In aseptic packaging, it is known to sterilise at least one surface of the packaging material in various ways. For example, it is known to use ultraviolet radiation and/or hydrogen peroxide solution to sterilise the inside surface of a partially completed container.

U.S. Pat. No. 4,121,107 discloses the use of a series of parallel mercury lamps, aluminium reflectors and a water-cooling system contained within a glass cover. The lamps emit ultraviolet radiation which is used to sterilise both surfaces of a web of packaging material.

It is also known to use pulses of light to irradiate a web of packaging material. For example, U.S. Pat. No. 4,871,559 discloses the use of pulsed ultraviolet light originating from a flashlamp system to sterilise the packaging material; the system also generates polychromatic radiation.

Other known methods employ a beam of ultraviolet radiation or infrared radiation produced by a UV-laser or an IR laser to sterilise the interior of a partially completed container after the inside surface of the partially completed container has been coated with hydrogen peroxide.

DE-A-2914075 discloses a system in which open-topped containers have their inside surfaces irradiated with UV from UV sources of elongate form insertable vertically from above into the containers which are being advanced therebelow on a conveyor.

U.S. Pat. No. 5,730,934 discloses a number of versions, one of which is similar to that of DE-A-2914075, except that the UV source has an aperture therethrough longitudinally thereof through which liquid food being filled into the container is used as a coolant for the UV source. U.S. Pat. No. 5,730,934 also discloses a version in which a partially completed carton open at both ends has such an UV source inserted vertically thereinto, except that in this version a non-food liquid coolant is passed through the aperture and falls into a discharge pipe below the open bottom end of the partially completed carton. U.S. Pat. No. 5,730,934 discloses that, at a station upstream of the UV source, a sterilant, for example hydrogen peroxide or ozone, may be sprayed into the partially completed cartons to enhance their sterilisation by the UV source, which is an excimer ultraviolet lamp.

U.S. Pat. No. 3,566,575 discloses sterilisation of partially completed, thermoplastics-coated paperboard cartons on a forming, filling and sealing machine, at a location between a station where the bottom-sealed carton is stripped from an indexing, bottom-closing and-sealing mandrel and a station downstream thereof where the carton is filled with a liquid, such as milk or juice, and the carton top is closed and sealed. At the sterilization location is an aseptic fogging and drying unit where a bactericide, for example hydrogen peroxide solution, sterilizes the inside surface of the bottom-sealed carton.

U.S. Pat. No. 4,590,740 discloses as known a system in which a channel is formed through each mandrel of an indexing mandrel spider on which a partially completed carton, in the form of a rectangular sleeve open at both ends, is bottom-closed and-sealed. Each channel communicates with openings and compartments formed in the hub of the spider such that, as each mandrel reaches the 6 o'clock position, at which the bottom-closed sleeve is stripped from the mandrel, there is communication with a generator of chlorine dioxide or hydrogen peroxide fog and the fog is conveyed to the interior of the bottom-closed sleeve via the channel. U.S. Pat. No. 4,590,740 discloses as inventive a method in which a partially completed carton, in the form of a rectangular sleeve open at both ends, has a sterilant fog applied thereinto from an external nebulising nozzle aligned with the interior of the carton sleeve, prior to the latter being mounted on the indexing mandrel spider on which the carton bottom is closed and sealed. If hydrogen peroxide is used as the sterilant, it may be necessary to include a drying unit at a station between the mandrel spider and the filling station, to remove the hydrogen peroxide residue from inside the carton sleeve.

U.S. Pat. No. 4,683,701 discloses a system somewhat similar to U.S. Pat. No. 4,590,740, except that the sterilant fog is applied while the carton sleeve is being opened from its flat condition to its rectangular condition prior to mounting on the mandrel spider.

### SUMMARY OF THE INVENTION

According to one aspect of the present invention, there is provided a method of rendering non-viable micro-organisms in a partially completed container, comprising causing a device to extend in said partially completed container, and, while the device is located in the partially completed container, emitting from the device radiation capable of rendering micro-organisms non-viable and simultaneously applying to the interior surface of the partially completed container a substance capable of rendering micro-organisms non-viable.

According to a second aspect of the present invention, there is provided apparatus for use in rendering non-viable micro-organisms in a partially completed container, comprising a device serving both to emit radiation capable of rendering micro-organisms non-viable and to emit a dispersion of a substance capable of rendering micro-organisms nonviable, and a drive arrangement serving to cause said device to extend in said partially completed container.

Owing to these aspects of the invention, it is possible at a single location both to emit microbiocidal radiation and to apply microbiocidal substance.

According to a third aspect of the present invention, there is provided a method of rendering non-viable microorganisms in a partially completed container open at opposite ends, comprising producing relative motion between a device and said partially completed container to insert said device into one of the open ends, and to advance said device in the interior of said partially completed container while producing from said device a dispersion of a substance capable of rendering micro-organisms non-viable and thereby applying said substance to the interior surface of the partially completed container.

Owing to this aspect of the invention, it is possible to improve the degree to which micro-organisms in a partially completed container are rendered non-viable.

According to a fourth aspect of the present invention, there is provided a method of rendering non-viable microorganisms in a partially completed container, comprising displacing said partially completed container over a device, and, while the device is located in the partially completed container, emitting from the device radiation capable of rendering micro-organisms non-viable.

According to a fifth aspect of the present invention, there is provided apparatus for use in rendering non-viable micro-organisms in a partially completed container, comprising a device serving to emit radiation capable of rendering micro-organisms non-viable, and a drive arrangement serving to displace said partially completed container over said device.

Owing to these aspects of the invention, whereby it is the partially completed container which is displaced to the radiation-emitting device, rather than the device being displaced to the partially completed container, the speed of operation can be enhanced, since a container can normally be moved more rapidly than a radiation-emitting device.

According to a sixth aspect of the present invention, there is provided a method of rendering non-viable microorganisms in a partially completed container open at opposite ends, comprising causing a mandrel to extend in said partially completed container from one of the open ends thereof, emitting from a device in said mandrel a medium capable of rendering micro-organisms in said partially completed container non-viable, and subsequently closing the other end of said partially completed container while the latter remains on said mandrel.

According to a seventh aspect of the present invention, there is provided apparatus for use in rendering non-viable micro-organisms in a partially completed container open at opposite ends, comprising a mandrel, a device in said mandrel serving to emit a medium capable of rendering micro-organisms in said partially completed container non-viable, a drive arrangement for causing said mandrel to extend in said partially completed container from one of the open ends, a closing arrangement disposed at a location along a path of transverse movement of said mandrel and serving to close the other end of said partially completed container, said device being arranged to be active in respect of said partially completed container before said closing arrangement is active in respect of said partially completed container.

Owing to these aspects of the invention, the partially completed container can have micro-organisms therein rendered non-viable while on a mandrel and still open at both ends and yet can be bottom-closed while still on the same mandrel.

According to an eighth aspect of the present invention, there is provided a method of rendering non-viable microorganisms in a partially completed container open at opposite ends, comprising causing a mandrel to extend in said partially completed container from one of the open ends, whereafter the other end of the partially completed container can be closed, and emitting from a device in said mandrel radiation capable of rendering micro-organisms in said partially completed container non-viable.

According to a ninth aspect of the present invention, there is provided apparatus for use in rendering non-viable micro-organisms in a partially completed container open at opposite ends, comprising a mandrel, a device in said mandrel serving to emit radiation capable of rendering microorganisms in said partially completed container non-viable, a drive arrangement for causing said mandrel to extend in said partially completed container from one of the open ends, and a closing arrangement serving to close the other end of said partially completed container.

Owing to these aspects of the invention, the partially completed container can be exposed to radiation which renders micro-organisms therein non-viable, while upon the same mandrel as that upon which it is bottom-closed.

According to a tenth aspect of the present invention, there is provided a method of rendering non-viable microorganisms in a partially completed container, comprising causing a device to extend in said partially completed container from an open end of said partially completed container, and advancing said device and said partially completed container simultaneously in a direction transverse to an axis of said partially completed container while emitting from said device a medium capable of rendering micro-organisms in said partially completed container nonviable.

According to an eleventh aspect of the present invention, there is provided apparatus for use in rendering non-viable micro-organisms in a partially completed container, comprising a device serving to emit a medium capable of rendering micro-organisms non-viable, a first drive arrangement serving to cause said device to extend in said partially completed container from an open end of said partially completed container, and a second drive arrangement serving to advance said device and said partially completed container simultaneously in a direction transverse to an axis of said partially completed container while said device emits said medium.

Owing to these aspects of the invention, the continuous exposure time of the partially completed container can be relatively long.

Generally owing to the invention, it is possible to achieve uniform distribution of, for example, hydrogen peroxide solution and UV-C irradiation on the inside surface of the partially completed container. Provided that relative movement at constant speed is produced between the partially completed container and the device, a uniform layer of hydrogen peroxide solution can be applied. The distance between the inside surface of the partially completed container and the UV-C-emitting part of the device is kept very short, in order to obtain maximum and substantially uniform irradiation of the inside surface.

The partially completed container may be a body in the form of a cup or beaker to which a lid is to be applied to complete the container, or may be in the form of a folded sleeve closed at one end and open at its other end which will later be folded and sealed to form a top closure. However, the partially completed container is preferably in the form of a sleeve which is open at both ends which subsequently either have caps applied thereto to close the sleeve sealingly, or have their ends folded and sealed to provide end closures.

The radiation emitted may, for example, be UV (preferably laser UV) and/or IR (preferably laser IR) and/or polychromatic light.

The substance may be hydrogen peroxide, chlorine dioxide, or ozone; whilst the dispersion may be in the form of a fog, but is preferably a spray.

The preferred embodiments have a number of important features which are now described. A first feature is the moving of an opened, square or rectangular, carton sleeve onto a meanwhile static rod-shaped source of germicidal radiation emitting radiation perpendicularly to its axis and 360° around this axis. Owing to this feature, a uniform irradiation of the carton inside surface is enabled. A second feature is the irradiating of the carton sleeve, while in place over the radiation source, for a period-of time. During this period of time, the assembly consisting of the radiation source and the carton sleeve around it, can move or rotate in a continuous or indexing manner. After the necessary exposure time, the carton sleeve is withdrawn from the radiation source back to the original location, or into a different location, in a packaging machine. Owing to this feature, a uniform and sufficient irradiation dosage on the inside surface of the carton sleeve is enabled. A significant point is the conveying of the carton sleeve through the machine during the sterilisation process. A third feature is the provision of a (chemical) sterilant disperser at the end of the rod-shaped radiation source and capable of emitting sterilant perpendicularly to the axis of the radiation source and 360° around this axis. This permits the utilisation of the sterilant disperser while the opened sleeve is moved onto the rod-shaped radiation source in a controlled manner (e.g. at constant speed). Owing to this feature, a uniform layer of sterilant can be applied to the carton inside surface. Combined with the already uniform irradiation and dosage enabled by the first and second features, this will enable uniform reaction and germicidal effect between the sterilant and the radiation. Another significant point is the application of sterilant and subjection of the carton to radiation at a common stage. A fourth feature is the optional provision of a mandrel cap at the outer end of the rod-shaped radiation source, enabling the open carton sleeve to be bottom sealed after the necessary exposure time without first being retracted from the radiation source. Owing to this feature, subsequent transfer to a conventional mandrel for bottom-closing and-sealing can be omitted.

### BRIEF DESCRIPTION OF THE DRAWINGS

In order that the invention may be clearly and completely disclosed, reference will now be made, by way of example, to the accompanying drawings, in which:

FIG. 1 shows diagrammatically a partially completed, gable topped carton being advanced towards guides and a device of a form-fill-seal packaging machine,

FIG. 2 is a view half in side elevation and half in axial section, of the partially completed carton, the guides and the device with the partially completed carton fully received in the guides, and

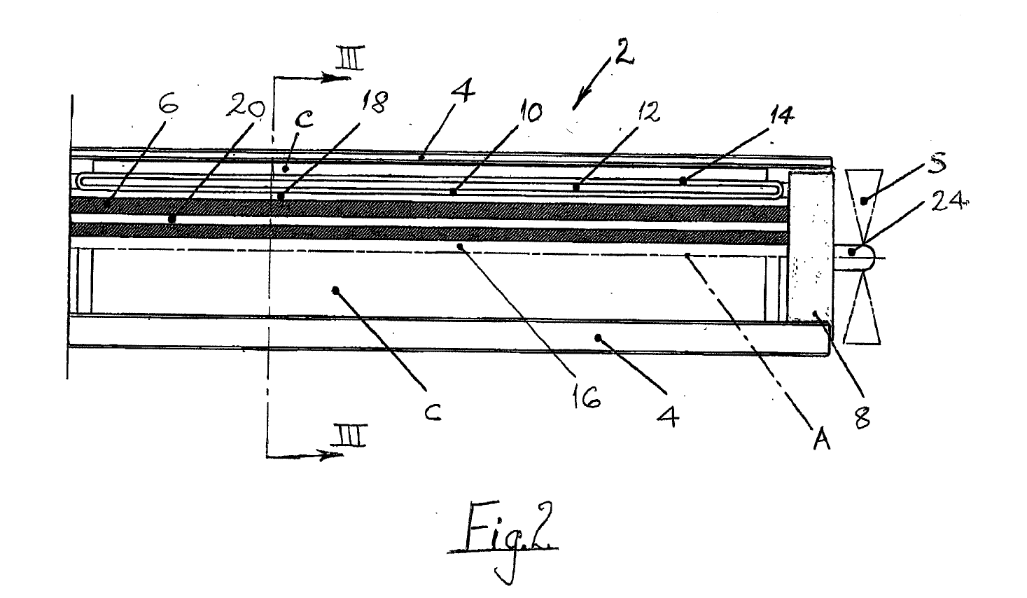

FIG. 3 shows a section taken on the line III-III of FIG. 2.

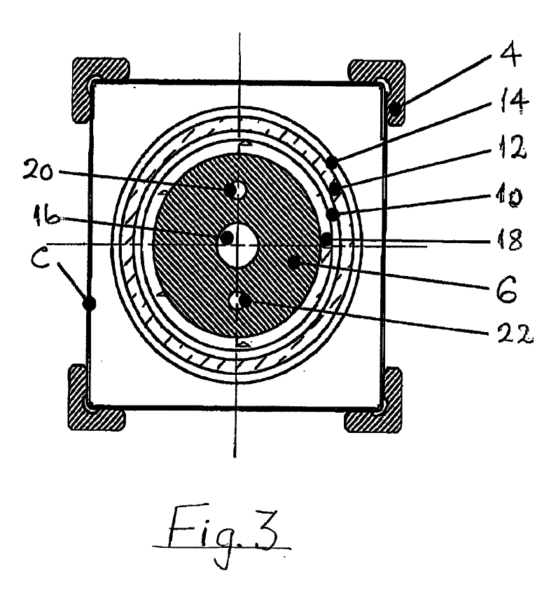

### DESCRIPTION OF THE PREFERRED EMBODIMENTS

The packaging machine is of the character disclosed in U.S. Pat. No. 4,590,740, except as will now be described with reference to the present drawings.

Provided between the blank feeder and loader assemblies, on the one hand, and the indexing mandrel spider upon which the cartons are bottom-closed and-sealed, on the other hand, is another indexing spider upon which micro-organisms in the interior of the carton sleeve, particularly upon the inside surface thereof, are rendered non-viable. Each of the arms of this spider consists of a device 2 and four carton sleeve guides 4 distributed parallelly around the device 2 at the corners of a square co-axial with the device 2 and of a size fittingly to receive a carton sleeve C. The guides 4 are each of angle form. The guides may be only two in number, at respective diametrically opposite corners of the device 2.

Each device 2 includes an excimer UV-C-lamp which is water-cooled. The lamp includes an elongate support member in the form of a rod 6 of which an inner end is fixed to the hub of the spider and of which the outer end may optionally have a mandrel cap 8 fixed thereto. Co-axially encircling and spaced from the rod 6 is an inner quartz glass wall 10 of an annular chamber 12 filled with excimer gas and outwardly bounded by an outer quartz glass wall 14. Cooling water (or cooling air) for the lamp flows from the inner end to the outer end of the rod 6 through an axial bore 16 therein. The cooling water returns through the annular space 18 between the rod 6 and the inner wall 10. There also extends through the rod 6 from the inner end to the outer end thereof and parallelly to each other and to the bore 16 respective bores 20 and 22, the bore 20 for the introduction of hydrogen peroxide solution and the bore 22 for the introduction of compressed air for atomising the hydrogen peroxide solution. The mandrel cap 8 contains conduits connecting the bore 16 to the space 18 and connecting the bores 20 and 22 to the interior of a nozzle 24 which is at the outer extremity of the device 2 and is co-axial with the rod 6. The nozzle 24 emits a spray S of hydrogen peroxide solution substantially perpendicularly to the axis A of the rod 6 throughout 360° around that axis.

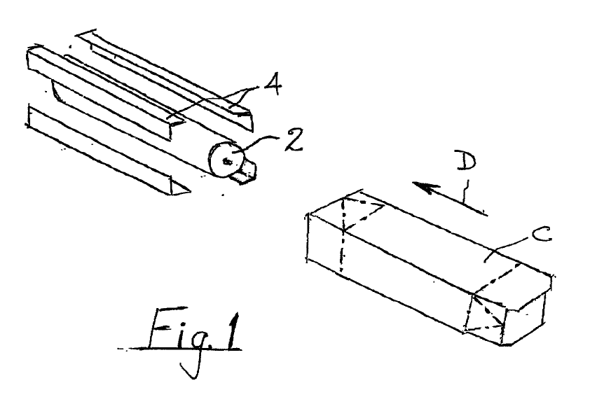

In operation, as illustrated in FIG. 1, the carton sleeve C is advanced in the direction of the arrow D coaxially with the device 2 and is thereby advanced along the insides of the carton guides 4, whereby the device 2 becomes inserted into the interior of the carton sleeve C. Immediately before the carton sleeve C begins to be received over the outer end of the device 2, the excimer UV-C lamp is switched on and the hydrogen peroxide solution begins to be sprayed from the nozzle 24. As the carton sleeve C advances in the guides 4, the device 2 continues to emit laser UV and the spray S continues to be applied to the inside surface of the carton sleeve C. Once the nozzle 24 projects from the outer end of the carton sleeve C, the spray S is switched off, but the lamp continues to irradiate the inside surface of the sleeve. This continues until the spider has indexed to a station at which the carton sleeve C with a now sterilized interior is stripped from the guides 4, ready to be aligned with a mandrel of the bottom-closing and-sealing spider. Instead of the excimer UV-C lamp and the delivery of hydrogen peroxide solution being switched on and off continually, either or both may be on continuously throughout normal operation of the packaging machine.

Assuming that the spider with each arm consisting of a device 2 and four guides 4 indexes according to the speed of the packaging machine, the length of irradiation time required to achieve sufficient dosage determines the minimum number of arms necessary.

If the rendering of the micro-organisms non-viable is to be performed upon the same mandrel spider as that upon which bottom-closing and-sealing is performed, so that an additional spider is not required, then each device 2 serves the purpose of a mandrel and in that case the mandrel cap 8 would be included against which the bottom of the carton sleeve would be closed and sealed.

When applied to a form-fill-seal machine of the character of U.S. Pat. No. 4,590,740, the basic invention can be implemented in a number of ways, including the following:

a) rendering micro-organisms non-viable with hydrogen peroxide solution and UV-C irradiation simultaneously, with the carton sleeve in the external guides, followed by transfer of the carton sleeves to the bottom-closing and-sealing spider;

b) rendering micro-organisms non-viable with UV-C irradiation only, with the carton sleeve in the external guides, followed by transfer of the carton sleeves to the bottom-closing and-sealing spider;

c) rendering micro-organisms non-viable with hydrogen peroxide solution and UV-C irradiation simultaneously, with the carton sleeve in the external guides, followed by bottom-closing and-sealing of the carton sleeve while it remains in the same guides; or

d) rendering micro-organisms non-viable with UV-C irradiation only, with the carton sleeve in the external guides, followed by bottom-closing and-sealing of the carton sleeve while it remains in the same guides.

I claim:

1. A method of rendering non-viable micro-organisms in a partially completed container, comprising causing a device to extend in said partially completed container, and, while the device is located in the partially completed container, emitting from the device radiation capable of rendering micro-organisms non-viable and simultaneously applying to the interior surface of the partially completed container a substance capable of rendering micro-organisms non-viable.

2. A method according to claim 1, wherein said causing of said device to extend in said partially completed container comprises displacing said partially completed container over said device.

3. A method according to claim 1 and further comprising, after said causing of said device to extend in said partially completed container, advancing said device and said partially completed container simultaneously in a direction transverse to said partially completed container while performing said emitting and said applying.

4. A method according to claim 1, wherein the distance between said interior surface of the partially completed container and a radiation-emitting part of said device is kept very short while said emitting is being performed.

5. A method according to claim 1, wherein the partially completed container is a body in the form of a cup or beaker, said method further comprising applying a lid to said body to complete the container.

6. A method according to claim 1, wherein said partially completed container is in the form of a folded sleeve closed at one end and open at its other end, said method further comprising folding and sealing said other end to form a top closure.

7. A method according to claim 1, wherein said partially completed container is open at opposite ends, and wherein said causing of said device to extend in said partially completed container comprises producing relative motion between said device and said partially completed container to insert said device into one of the open ends, and to advance said device in the interior of said partially completed container while said emitting and said applying are being performed.

8. A method according to claim 7, wherein said relative movement between said device and said partially completed container is at substantially constant speed while said emitting and said applying are being performed.

9. A method according to claim 7, wherein said causing of said device to extend in said partially completed container comprises causing a mandrel containing said device to extend in said partially completed container from one of the open ends thereof, said method including, after said emitting, closing the other end of said partially completed container while the latter remains on said mandrel.

10. A method according to claim 7, and further comprising either applying caps to the respective opposite ends of the partially completed container to close the partially completed container sealingly, or folding and sealing the respective opposite ends to provide end closures.

11. A method according to claim 1, wherein said radiation is emitted substantially perpendicularly to a common longitudinal axis of said partially completed container and of said device and substantially throughout 360° around this axis.

12. A method according to claim 11, wherein said substance is emitted from an outer end of said device substantially perpendicularly to said axis and substantially throughout 360° around this axis.

13. Apparatus for use in rendering non-viable microorganisms in a partially completed container, comprising a device serving both to emit radiation capable of rendering micro-organisms non-viable and to emit a dispersion of a substance capable of rendering micro-organisms non-viable, and a drive arrangement serving to cause said device to extend in said partially completed container.

14. Apparatus according to claim 13, wherein said drive arrangement serves to displace said partially completed container over said device.

15. Apparatus according to claim 13, and further comprising a mandrel containing said device, said drive arrangement serving to cause said mandrel to extend in said partially completed container from one of opposite open ends of said partially completed container, and a closing arrangement disposed at a location along a path of transverse movement of said mandrel and arranged to close the other end of said partially completed container, said device being arranged to be active in respect of said partially completed container before said closing arrangement is active in respect of said partially completed container.

16. Apparatus according to claim 13, and further comprising a second drive arrangement serving to advance said device and said partially completed container simultaneously in a direction transverse to said partially completed container while said device emits said radiation.

17. Apparatus according to claim 13, wherein said device comprises a rod-shaped source of said radiation serving to emit radiation substantially perpendicularly to a longitudinal axis of said rod-shaped source and substantially throughout 360° around this axis.

18. Apparatus according to claim 17, wherein said device comprises a disperser at an outer end of said rod-shaped source and capable of emitting said substance substantially perpendicularly to said longitudinal axis and through substantially 360° around this axis.

19. Apparatus according to claim 13 and further comprising a mandrel cap at an outer end of said rod-shaped source and enabling the partially completed container to be bottom-sealed.

20. A method of rendering non-viable micro-organisms in a partially completed container open at opposite ends, comprising producing relative motion between a device and said partially completed container to insert said device into one of the open ends, and to advance said device in the interior of said partially completed container while producing from said device a dispersion of a substance capable of rendering micro-organisms non-viable and thereby applying said substance to the interior surface of the partially completed container.

21. A method according to claim 20, wherein said relative movement said device and said partially completed container is at substantially constant speed while said applying is being performed.

22. A method according to claim 20, wherein said producing of said relative movement comprises causing a mandrel containing said device to extend in said partially completed container from one of the open ends thereof, said method including, after said advance of said device, closing the other end of said partially completed container while the latter remains on said mandrel.

23. A method of rendering non-viable micro-organisms in a partially completed container, comprising displacing said partially completed container over a device, and, while the device is located in the partially completed container, emitting from the device radiation capable of rendering micro-organisms non-viable.

24. Apparatus for use in rendering non-viable microorganisms in a partially completed container, comprising a device serving to emit radiation capable of rendering microorganisms non-viable, and a drive arrangement serving to displace said partially completed container over said device.

25. A method of rendering non-viable micro-organisms in a partially completed container open at opposite ends, comprising causing a mandrel to extend in said partially completed container from one of the open ends thereof, emitting from a device in said mandrel a medium capable of rendering micro-organisms in said partially completed container non-viable, and subsequently closing the other end of said partially completed container while the latter remains on said mandrel.

26. Apparatus for use in rendering non-viable microorganisms in a partially completed container open at opposite ends, comprising a mandrel, a device in said mandrel serving to emit a medium capable of rendering micro-organisms in said partially completed container non-viable, a drive arrangement for causing said mandrel to extend in said partially completed container from one of the open ends, a closing arrangement disposed at a location along a path of transverse movement of said mandrel and serving to close the other end of said partially completed container, said device being arranged to be active in respect of said partially completed container before said closing arrangement is active in respect of said partially completed container.

27. A method of rendering non-viable micro-organisms in a partially completed container open at opposite ends, comprising causing a mandrel to extend in said partially completed container from one of the open ends, whereafter the other end of the partially completed container can be closed, and emitting from a device in said mandrel radiation capable of rendering micro-organisms in said partially completed container non-viable.

28. Apparatus for use in rendering non-viable microorganisms in a partially completed container open at opposite ends, comprising a mandrel, a device in said mandrel serving to emit radiation capable of rendering micro-organisms in said partially completed container non-viable, a drive arrangement for causing said mandrel to extend in said partially completed container from one of the open ends, and a closing arrangement serving to close the other end of said partially completed container.

29. A method of rendering non-viable micro-organisms in a partially completed container, comprising causing a device to extend in said partially completed container from an open end of said partially completed container, and advancing said device and said partially completed container simultaneously in a direction transverse to an axis of said partially completed container while emitting from said device a medium capable of rendering micro-organisms in said partially completed container non-viable.

30. Apparatus for use in rendering non-viable microorganisms in a partially completed container, comprising a device serving to emit a medium capable of rendering microorganisms non-viable, a first drive arrangement serving to cause said device to extend in said partially completed container from an open end of said partially completed container, and a second arrangement serving to advance said device and said partially completed container simultaneously in a direction transverse to an axis of said partially completed container while said device emits said medium.
